(19) United States
(12) Patent Application Publication
(10) Pub. No.: US 2013/0135243 A1
(43) Pub. Date: May 30, 2013

(54) CHARACTER PREVIEW METHOD AND APPARATUS

(71) Applicants: Alexander Samson Hirsch, Highland Park, IL (US); Karin Callahan, Bensenville, IL (US)

(72) Inventors: Alexander Samson Hirsch, Highland Park, IL (US); Karin Callahan, Bensenville, IL (US)

(73) Assignee: RESEARCH IN MOTION LIMITED, Waterloo, ON (CA)

(21) Appl. No.: 13/814,649

(22) PCT Filed: Jun. 29, 2011
(86) PCT No.: PCT/US11/42304

§ 371 Date: Feb. 6, 2013

(51) Int. Cl. G06F 3/041

(52) U.S. Cl. CPC G06F 3/041
USPC 345/173

(57) ABSTRACT

A method and apparatus include detecting a first touch meeting a first threshold, which first touch is detected on a first physical key and displaying, without entering, at least a first character associated with the first physical key in an information entry field on an electronic device in response to the detecting.

### FIELD OF TECHNOLOGY

The present disclosure relates to electronic devices, including but not limited to, portable electronic devices displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include, for example, several types of mobile stations such as simple cellular telephones, smart telephones, wireless personal digital assistants (PDAs), and laptop computers with wireless 802.11 or Bluetooth capabilities.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. The information displayed on the touch-sensitive displays may be modified depending on the functions and operations being performed. With continued demand for decreased size of portable electronic devices, touch-sensitive displays continue to decrease in size.

Improvements in devices with touch-sensitive displays are desirable.

### BRIEF DESCRIPTION OF THE DRAWINGS

FIG. 1 is a block diagram of a portable electronic device in accordance with the disclosure.

FIG. 2 is a flowchart illustrating a method of previewing a character in accordance with the disclosure.

FIG. 3 is a front view of an electronic device with a character previewed on the display in an alternate format in accordance with the disclosure.

FIG. 4 is a side view of a physical key with a touch-sensitive element in accordance with the disclosure.

FIG. 5 is a side view of a physical key with a force sensor in accordance with the disclosure.

FIG. 6 is a flowchart illustrating a method of previewing characters associated with a number in a phone application in accordance with the disclosure.

FIG. 7 is a front view of an electronic device with a number and associated letters previewed on the display in accordance with the disclosure.

FIG. 8 through FIG. 10 show front views of an electronic device with one or more characters previewed on the display in accordance with the disclosure.

### DETAILED DESCRIPTION

The following describes an apparatus for and method of displaying, for example, by previewing, at least one character associated with a physical key. When a touch that meets a threshold is detected, at least one character associated with the physical key is previewed in response to the detecting. The preview format is advantageously a format different than the format of information previously entered in an information entry field. Convenience characters may be previewed in addition to the number associated with the convenience characters, for example, to facilitate entering of phone numbers including letters or characters. Previewed characters may be entered or subsequently changed.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to an electronic device, such as a portable electronic device or non-portable electronic device. Examples of portable electronic devices include mobile, or handheld, wireless communication devices such as pagers, cellular phones, cellular smart-phones, wireless organizers, personal digital assistants, wirelessly enabled notebook computers, tablet computers, mobile internet devices, and so forth. The portable electronic device may be a portable electronic device without wireless communication capabilities, such as handheld electronic games, digital photograph albums, digital cameras, media players, e-book readers, and so forth. Examples of non portable electronic devices include desktop computers, electronic white boards, smart boards utilized for collaboration, built-in displays in furniture or appliances, and so forth.

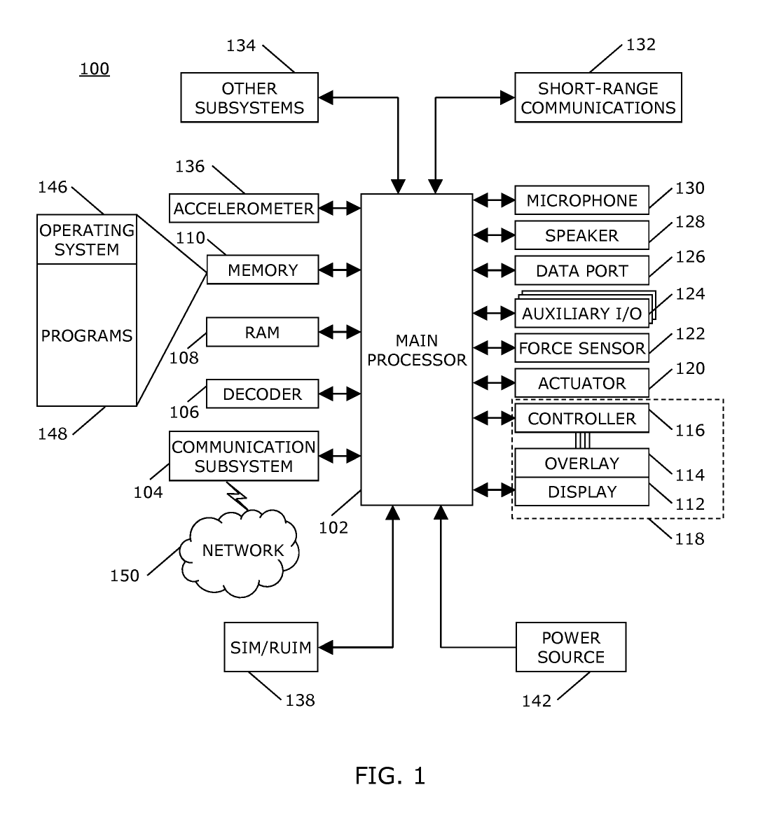

A block diagram of an example of a portable electronic device 100 is shown in FIG. 1. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as Random Access Memory (RAM) 108, memory 110, a display 112 with an optional touch-sensitive overlay 114 operably coupled to an optional electronic controller 116 that together comprise an optional touch-sensitive display 118, one or more actuators 120, one or more force sensors 122, an auxiliary input/output (I/O) subsystem 124, a data port 126, a speaker 128, a microphone 130, short-range communications 132, and other device subsystems 134. User-interaction with a graphical user interface is performed through the touch-sensitive overlay 114. The processor 102 interacts with the touch-sensitive overlay 114 via the electronic controller 116. Information, such as text, characters, symbols, images, icons, and other items that may be displayed or rendered on a portable electronic device, is displayed on the touch-sensitive display 118 via the processor 102. The processor 102 may interact with an accelerometer 136 that may be utilized to detect direction of gravitational forces or gravity-induced reaction forces.

To identify a subscriber for network access, the portable electronic device 100 uses a Subscriber Identity Module or a Removable User Identity Module (SIM/RUIM) card 138 for communication with a network, such as the wireless network 150. Alternatively, user identification information may be programmed into memory 110.

The portable electronic device 100 includes an operating system 146 and software programs or components 148 that are executed by the processor 102 and are typically stored in a persistent, updatable store such as the memory 110. Additional applications or programs may be loaded onto the portable electronic device 100 through the wireless network 150, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the portable electronic device 100 is similar. The speaker 128 outputs audible information converted from electrical signals, and the microphone 130 converts audible information into electrical signals for processing.

Physical keys on electronic devices, such as portable electronic devices, may be small. When more physical keys are provided, such keys tend to be smaller than when fewer physical keys are provided. Small keys have limited space available to print, stamp, engrave, or otherwise mark one or more characters associated with the physical key. Characters include numbers, letters, symbols, and so forth, for any language. In some instances, space is available for only one or two characters. Such small keys are unable to identify multiple characters, such as letters, that may be associated with a number on the physical key. When dialing a phone number or entering text, a user cannot see associated letters or characters marked on the physical key because such letters or characters are not labeled on the key. For example, dialing a phone number given with letters or characters, such as 1-800-THE-AQUA, may be difficult. Further, smaller keys may be covered by an input member, such as a finger or thumb, and the character on the key may not be visible. The following describes a method and apparatus for displaying, for example, by previewing, a character associated with a physical key. The character may be previewed before the character is entered. Errors entering characters are reduced.

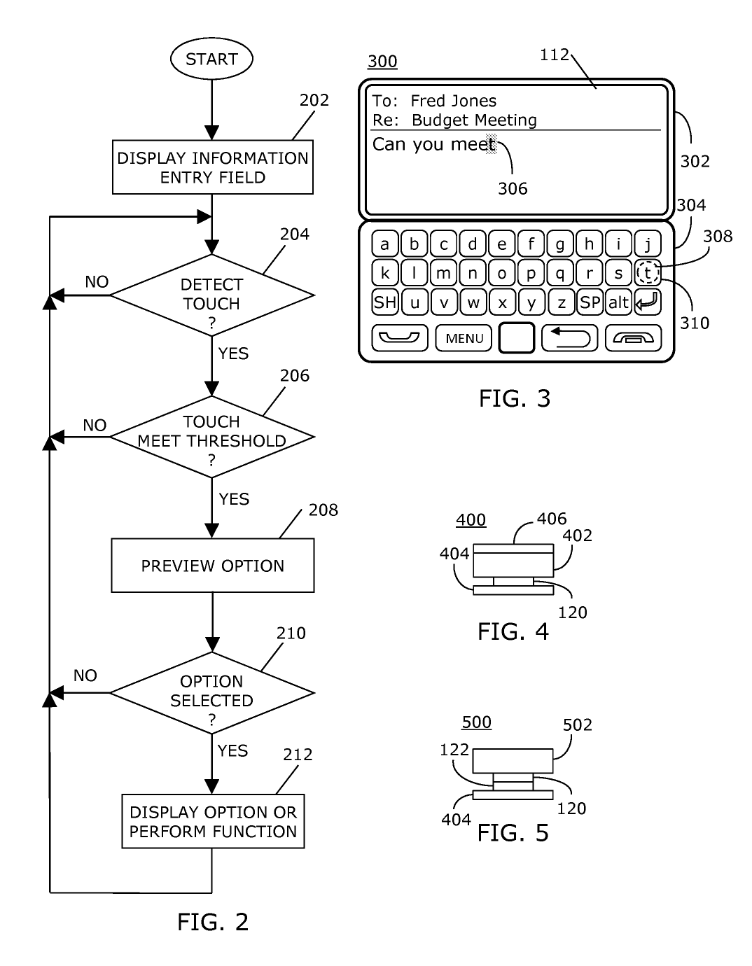

A flowchart illustrating a method of previewing a character is shown in FIG. 2. The method may be carried out by software executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium.

Information is displayed 202 in an information entry field on the display 112. The information may include selection options, for example, icons, text, lists such as emails or contacts, and selection windows or decision boxes such as unlock, delete, cancel, and so forth. The information may also include an information entry field, such the field utilized to enter or input information, for example, text in an email or text message, names and related information in a contacts list, information in a game, addresses for websites, and so forth.

When a touch is detected 204 on a physical key, which touch meets a threshold 206, at least one character associated with the physical key is previewed 208 by displaying information associated with the at least one character, for example, in a preview format. The threshold may be a time threshold, a force threshold, an actuation threshold, a capacitive threshold, and so forth. A value meets a threshold when the value equals or exceeds the threshold. Previewed characters are not entered into the information entry field or input to the electronic device, but rather are displayed prior to entry of any character.

A preview format may be any suitable format, such as a noticeably different format than the format of information previously entered in the information entry field. For example, when information is previewed in the information entry field, a character may be displayed in a ghosted, faded, highlighted, shadowed, shaded, underscored, italicized, bolded, blinking, animated, encircled, or other version of the character, which format is different than the format of the information entered in the information entry field. Preview formatting may also include a different color or font, as well as different size, e.g., enlarged or shrunken version, of the character. Preview formatting may be utilized in conjunction with a cursor. Combinations of formatting may be utilized, such as bold, italics, and underlined in an off color, or highlighted with a cursor, and so forth. The previewed character may be displayed after the last character entered in the information field, i.e., next to any previously entered character. Alternatively, the previewed selection option may be displayed in an information field shaped like a balloon, box, or window in a location that is remote from the location of the touch such that the information is visible.

A portable electronic device 300, similar to the portable electronic device 100 of FIG. 1, includes a display section 302 comprising a display 112 and a physical key section 304 comprising a plurality of physical keys 310 as shown in FIG. 3. In this example, an email is in the process of being completed, and a shaded area 306 is provided to preview the character “t” in response to a touch detected at a location 308 on the physical key labeled “t” in FIG. 3, which touch meets the threshold. Thus, characters for physical keys may be previewed in a visible manner before being entered or input by a user. For example, a character may be displayed in an alternate format without entering the character in the text field. Information may be previewed, for example, as long as the touch associated with the physical key meets the threshold. The electronic device provides the user with the ability to change the character prior to entry in the information entry field.

When one of the physical keys is actuated or selected 210, and the physical key is associated with a character, the character indicated for selection is entered or input in the information entry field and displayed 212, for example, in the format of information previously entered in the information entry field, which may be referred to as a normal, standard, or default format. When one of the physical keys is actuated or selected 210, and the physical key is associated with a function, the function is performed. For example, when the physical key is associated with an alternate keyset such as numbers, symbols, punctuation, shift, shift lock, and so forth, the function is performed, for example, a numerical keyset is displayed. When a touch is detected on a physical key associated with a function, one or more characters, including symbols, associated with that function are previewed.

A user may hover over or touch several different physical keys before selecting or actuating one. A preview of each of the different characters associated with the physical keys is provided as long as a touch is detected meeting the threshold for each option. When the touch does not meet the threshold, the preview is discontinued. A physical key may optionally be selected or actuated without a preview being displayed, such as when a longer time threshold is utilized. A profile may be utilized to store a user's preferences for thresholds.

A side view of an example of a physical key 400 with a touch-sensitive element 406 is shown in FIG. 4. The physical key 400 includes a body 402 disposed in alignment with an actuator 120 that is disposed on a base 404. Each physical key 400 may have its own base or a plurality of physical keys 400 may be disposed on the same base. The touch-sensitive element 406 is shown disposed on the outer part of the physical key 400, although other arrangements are possible, such integrating the touch-sensitive element 406 integrated into the body 402 or within a cavity of the body. Optionally, a cover may be part of the touch-sensitive element 406, which cover protects the touch sensor of the touch-sensitive element 406. The optional touch-sensitive element may include any suitable touch sensor, such as a capacitive, resistive, infrared, surface acoustic wave (SAW), strain gauge, optical imaging, dispersive signal technology, acoustic pulse recognition, and so forth, as known in the art. A capacitive touch-sensitive element includes a capacitive touch-sensitive electrode, which may be part of an overlay. The electrode may be an assembly of multiple layers in a stack including, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

One or more touches, also known as touch contacts or touch events, may be detected by the touch-sensitive element 406. The processor 102 may determine attributes of the touch, including a location of a touch, which may simply be which physical key is touched, how long the physical key is touched, the character(s) associated with each physical key, and so forth. Touch location data may include an area of contact or a single point of contact, such as a point at or near a center of the area of contact. The location of a detected touch may include x and y components, e.g., horizontal and vertical components, respectively, with respect to one's view of the touch-sensitive element. For example, the x location component may be determined by a signal generated from one touch sensor, and the y location component may be determined by a signal generated from another touch sensor. Optionally, a single touch sensor may be provided for each physical key, which touch sensor may provide simple touch data, such as a binary output of “0” when a touch is not detected and “1” when a touch is detected. A signal is provided to the controller 116 in response to detection of a touch. A touch may be detected from any suitable input member, such as a finger, thumb, appendage, or other objects, for example, a stylus, pen, or other pointer, depending on the nature of the touch-sensitive element. Multiple simultaneous touches may be detected on different physical keys.

A touch or time threshold may be utilized with a physical key 400 including a touch-sensitive element 406. The threshold may be a touch threshold that may simply be a touch detected by a touch-sensitive element 406. The threshold may alternatively be a time threshold, wherein the time that a touch remains detected in association with the same physical key 400 without actuating the physical key 400 is compared to the time threshold. For example, the threshold may be 0 seconds, 0.25 seconds, 0.5 seconds, 0.75 seconds, 1 second, and so forth. The time that the touch remains detected may be referred to as a hover time. The threshold time may be an option selected by the user. A range of time thresholds may be chosen from effectively 0 seconds, i.e., from detection of a touch, to a longer period such as 1 second or longer. A user may be able to turn on previewing for every touch (e.g., 0 seconds) or turn off previewing completely (e.g., infinite hover time).

A side view of an example of a physical key 500 with a force sensor 122 is shown in FIG. 5. The physical key 500 includes a body 502 disposed in alignment with a force sensor 122 that is disposed on a base 404 and an optional actuator 120. Each physical key 500 may have its own base or a plurality of physical keys 400 may be disposed on the same base. The order of the actuator 120 and the force sensor 122 may be different than the order shown in the example of FIG. 5. The force sensor 122 and actuator 120 may be integrated into the body 502 or disposed within a cavity of the body. The force sensor 122 may be disposed in conjunction with or integrated with the physical key 500 to determine or react to forces applied to the physical key 500. The force sensor 122 may be disposed in line with the optional actuator 120. The force sensors 122 may be force-sensitive resistors, strain gauges, piezoelectric or piezoresistive devices, pressure sensors, quantum tunneling composites, force-sensitive switches, or other suitable devices. Force as utilized throughout the specification, including the claims, refers to force measurements, estimates, and/or calculations, such as pressure, deformation, stress, strain, force density, force-area relationships, thrust, torque, and other effects that include force or related quantities. Two different force values may be utilized to provide two different force thresholds.

One or more force values may be utilized as thresholds. One force threshold may be utilized to preview one or more characters associated with the physical key 500, and a second force threshold may be utilized to enter or input the character associated with the physical key 500. For example, the second force threshold may be the force that actuates the physical key. In this example, characters are previewed while the lower force threshold is met, but the second force threshold is not met. Characters are entered when the second force threshold is met. Different types of thresholds may utilized for the two different thresholds. For example, the first threshold may be a time or capacitive threshold and the second threshold may be a force threshold.

The actuator 120 may be depressed or activated by applying sufficient force to a physical key 400, 500 to overcome the actuation force of the actuator 120. The actuator 120 may provide input to the processor 102 when actuated, which input may be utilized as meeting one of two thresholds. A two-level actuator may be utilized, wherein meeting the first threshold occurs when the first level of actuation occurs, e.g., a lower force, resulting in preview of an associated character, and meeting the second threshold occurs when the second level of actuation occurs, e.g., pressing further or harder, in response to which the character associated with the key is entered. Actuation of the actuator 120 may result in provision of tactile feedback.

A combination of elements may be utilized to provide two different thresholds. For example, a touch-sensitive element may provide the first threshold when a touch is detected that meets a time threshold, e.g., 50 ms, and an actuator may provide the second threshold, e.g., when the actuator is actuated, which may be referred to as depressing a physical key. Such a device may be, for example, a physical key with a touch sensor disposed on, within, or under the physical key, such as shown in FIG. 4. Alternatively, a force sensor 122 may be disposed with a physical key such that a force value from the force sensor provides the first threshold and an actuator 120 of the physical key provides the second threshold, for example, as shown in FIG. 5. Other elements and combinations may be provided. More than two thresholds may be utilized.

Character or letter mapping is known for use with phone numbers. For example, the Aqua Restaurant may simplify its phone number 1-800-843-2782 as 1-800-THE-AQUA for the purpose of providing a more memorable phone number in advertising. Character or letter mapping may also be utilized for text messaging, entering contact information in a portable electronic device, and so forth. One example of character or letter mapping is as follows:

0=none

1=none

2=ABC

3=DEF

4=GHI

5=JKL

6=MNO

7=PQRS

8=TUV

9=WXYZ

Other characters may be utilized than the letters shown. Other number-character mappings may be utilized than the above example. Such characters will be referred to herein as convenience characters or convenience letters.

The physical keys on a portable electronic device may be too small to mark the convenience characters. The example portable electronic device of FIG. 7 illustrates multiple characters on several keys, although the numbers and letters associated with each physical key do not match the number-letter mapping shown in the example above. Thus, entering a phone number including convenience characters or letters with such a keyboard may be difficult.

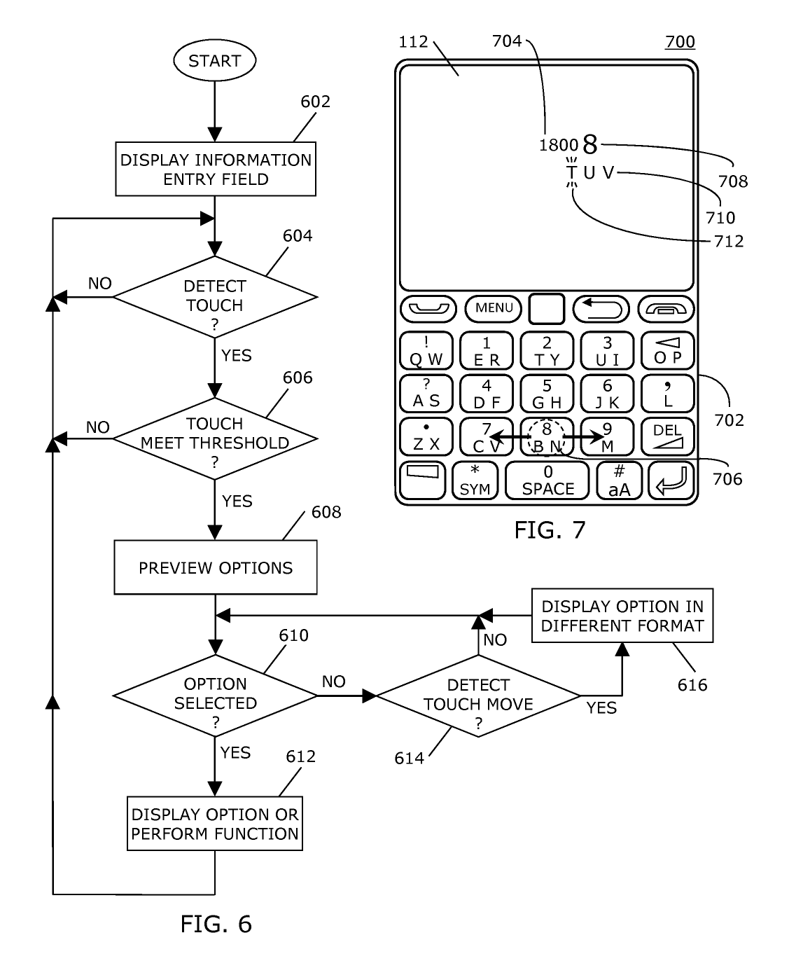

A flowchart illustrating a method of previewing characters associated with a number, for example, in a phone application is shown in FIG. 6. The method may be carried out by software executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium.

Information is displayed 602 in an information entry field on the display 112, for example, as described above. When a touch is detected 604 on a physical key, which touch meets a threshold 606, at least one character associated with the physical key is previewed 608 by displaying information associated with the at least one character, for example, in a preview format, such as described above. The threshold may be a time threshold, a force threshold, an actuation threshold, and so forth. Previewed characters are not entered into the information entry field or input to the electronic device, but rather are displayed prior to entry of any character.

A portable electronic device 700, similar to the portable electronic device 100 of FIG. 1, includes a display 112 and a plurality of physical keys 702 as shown in FIG. 7. In this example, a phone number is in the process of being entered in a phone application. The physical keys may automatically default to entering numbers while in a phone application. “1800” was previously entered, and a touch meeting a threshold at a location 706 on the “8” physical key. An “8” in a larger font size 708 is previewed in addition to the convenience characters “TUV” 710 that are associated with the number “8” in a character-number mapping, for example, for a phone.

If an option is not selected 610, and the touch moves 614 to a different physical key, the options for the new physical key are displayed in a different format, such as the preview format described above. For example, if the touch moves to the right to the “9” physical key, a large “9” is displayed next to the “1800” previously entered, and “WXYZ” is displayed below the “9” on the display 112. If the touch moves to the left to the “7” physical key, a large “7” is displayed next to the “1800” previously entered, and “PQRS” is displayed below the “7” on the display 112. Thus, convenience characters for numbers on physical keys may be previewed in a visible manner before being entered or selected by a user. The electronic device provides the user with the ability to change the character prior to selection or entry. When the user does not know which characters are associated with a number, as the user moves a finger along the number keys, the associated convenience characters or letters are displayed.

Optionally, the convenience character may be entered and displayed in addition to the number. When this option is utilized, the numbers and characters are displayed. For example, “1-800-843-2782” may be displayed with “THE-AQUA” displayed below or above “843-2782” on the display 112. The “T” is shown in a blinking format 712 in FIG. 7. Although blinking is shown in this example, other preview formats, such as described above, may be utilized. When the “8” is entered, both the “8” and the “T” are displayed. The highlighted convenience character may be changed, for example, by detecting movement of the touch along the physical key or across multiple physical keys. In the example of FIG. 7, the touch location may slide left or right along the “8” key, as shown by the arrows, to change which convenience character is highlighted. Alternatively, a touch on one or more other different physical keys may be utilized to change which convenience character is identified by an alternative format. For example, while touching the “8” key with one finger, a second finger may touch another key, such as the “2” key, to change the highlighted convenience character. For example, one detected touch highlights the “U” character, a second detected touch highlights the “V” character, and a third detected touch highlights the “T” character, and so forth. Alternatively, subsequent touches detected on different physical keys may be change which convenience character is highlighted. A finger may be moved alternatively across the physical keys to change the highlighted convenience character. For example, detection of touches moving to the left moves the highlighted convenience character to the left; detection of touches moving to the right moves the highlighted convenience character to the right. The convenience character may optionally be selected separately and after entry of the number.

When one of the physical keys is actuated or selected 610, and the physical key is associated with a character, the character selected is entered in the information entry field and displayed 612, for example, in the format of information previously entered in the information entry field, which may be referred to as a normal, standard, or default format. When one of the physical keys is actuated or selected 612, and the physical key is associated with a function, the function is performed, such as described above.

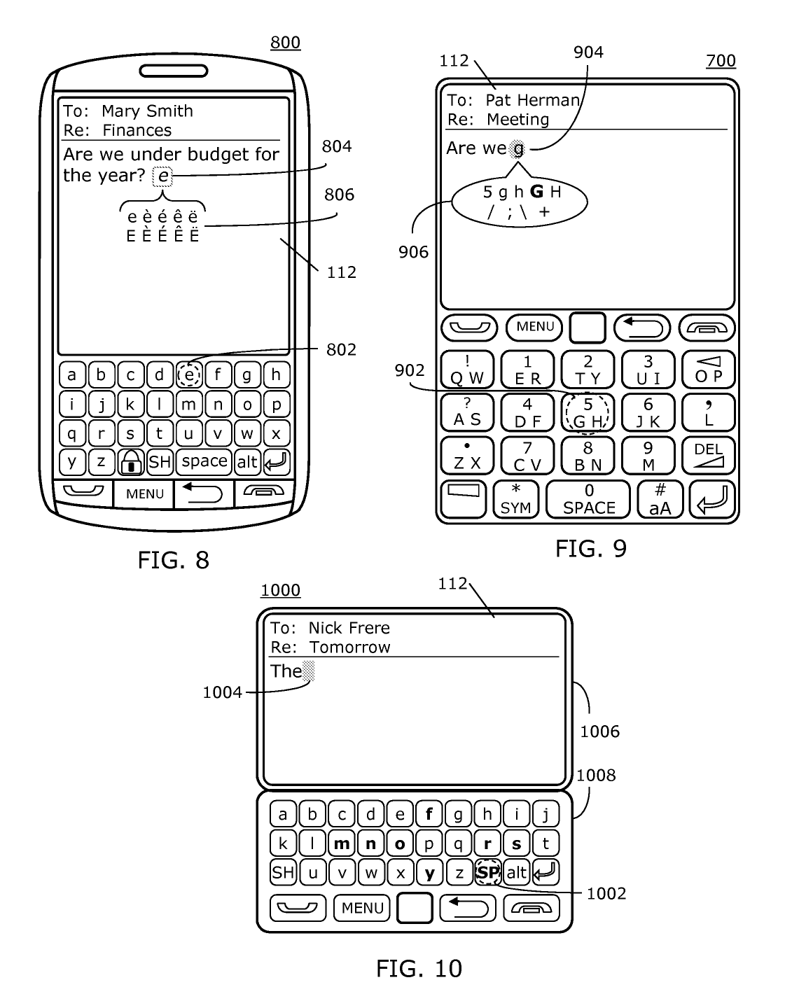

A plurality of characters associated with a physical key are shown displayed in FIG. 8. When a touch meeting a first threshold is detected at a location 802 on the “e” physical key, in addition to displaying the “e” in an alternative format 804, possible characters 806 associated with the character or physical key are displayed in this example. The “e” is shown in a format 804 that is italicized and encircled. In this example, alternatives of “e” including various accents and markings as well as capitalized options are shown. The character itself, which may be a default character, or one of the alternatives may be selected or entered in the text field as described above.

Multiple characters associated with a physical key are shown displayed in FIG. 9. When a touch meeting a first threshold is detected at a location 902 on the “5 G H” physical key, various possible characters 906 associated with the character or physical key are displayed in this example. The “g” is shown in a format 904 that is shaded. In this example, the basic characters on the key, “5” and “g” and “H” are displayed, as well as alternatives including capitalized options, characters resulting from use of an alternate character key, such as a “SYM” key, “NUM” key, or “ALT” key, while depressing the “5 G H” key. A capitalized “G” is highlighted in bold because this alternative character is detected as indicated for selection if the “5 G H” key is depressed. The character itself or one of the alternatives may be indicated for selection and entered in the text field as described above. A character indicated for selection is one of the previewed characters. When the physical key is depressed, the character indicated for selection is entered or input in the information entry field.

A plurality of characters associated with a physical key are shown highlighted in FIG. 10. When a touch meeting a first threshold is detected at a location 1002 on the space (“SP”) physical key, a space is shown in an alternative format 1004. Optionally, a predictive text algorithm may be utilized to identify possible next characters. In this example, the characters “f” (theft), “m” (them), “n” (then), “o” (theory), “r” (there), “s” (these), “y” (they), and the space key are shown in a backlit manner to facilitate easier location of the most likely next candidate keys by a user. One or more light emitting diodes or other light sources may be utilized to backlight the keys associated with possible next characters such that these keys are visually identifiable. Optionally, the “SYM” key, “NUM” key, or “ALT” key may also be backlit as appropriate. In this example, an electronic device 1000 includes a smartphone 1006 and a keyboard accessory.

A user may hover over or touch several different physical keys before selecting or actuating one. Alternatively, a touchscreen, trackpad, optical joystick, or other device may be utilized to select or enter a character. For example, the previewed character may selected when a touch is detected in an area associated with the displayed character, e.g., when a user directly touches the touch-sensitive display at or near the area where the desired character is displayed. A preview of the number and the convenience characters associated with the number is provided as long as a touch is detected meeting the threshold. When the touch does not meet the threshold, the preview is discontinued. A physical key may optionally be selected or actuated without a preview being displayed, such as when a longer time threshold is utilized.

Optionally, a text indicator, such as a cursor, may be displayed to assist with text editing, such as inserting or deleting characters. The text indicator may be displayed, for example, when a double or triple tap is detected on a single key, when simultaneous touches or touches that overlap in time are detected on two different physical keys, by menu selection, and so forth. Such taps may be detected, for example, by touch-sensitive elements 406 on the physical keys 400. The text indicator may be moved through the displayed characters in the information entry field based on relative movement of detected touches on the plurality of physical keys 400. For example, the text indicator may be moved upward by touching the “6” and “3” keys in order. The text indicator may be moved downward by touching the “1” and “4” keys in order. The text indicator may be moved to the left by touching the “6” and “5” keys in order. The text indicator may be moved to the right by touching the “1” and “2” keys in order. Any physical keys may be touched in sequence to provide the desired movement of the text indicator. In this way, the plurality of keys 400 acts as a unified touch-sensitive device, such as a trackpad, optical joystick, or touch-sensitive display.

Optionally, tactile feedback may be provided in conjunction with the preview of the information. For example, a low-amplitude vibration or buzz may be provided at the beginning of a preview or for the duration of the preview. Such tactile feedback may be provided, for example, by one or more piezoelectric devices or a vibrator motor.

Circles are shown representing locations 308, 706 of touches for the simplicity of the drawing, although the detected touch may be resolved into a single point, multiple points, or an area of contact other than a circle.

Characters associated with physical keys are previewed in an information entry field prior to selection or entry. A user may hover over or touch several different physical keys before selecting or actuating one, thereby reducing input errors. Convenience characters are displayed with numbers to facilitate easier entry of phone numbers that include letters or characters. By previewing multiple characters associated with a physical prior to entering the characters, a user may be able to learn which physical keys are associated with which characters. By utilizing two different thresholds, a touch that meets a first threshold facilitates previewing one or more characters, and a touch that meets a second threshold facilitates entering one of the one or more characters. Different types of thresholds may be utilized for the two different thresholds. Physical keys may be integrated into an electronic device or may be part of a keyboard or keypad accessory.

A method and apparatus include detecting a first touch meeting a first threshold, which first touch is detected on a first physical key and displaying, without entering, at least a first character associated with the first physical key in an information entry field on an electronic device in response to the detecting. An electronic device comprises a display, a plurality of physical keys, and a processor operably coupled to the display and the plurality of keys and configured to detect a first touch meeting a first threshold, which first touch is detected on a first physical key of the plurality of physical keys and display and not enter at least a first character associated with the first physical key on the display in an information entry field in response to the detecting.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method comprising:
detecting a first touch meeting a first threshold, which first touch is detected on a first physical key;
displaying, without entering, at least a first character associated with the first physical key in an information entry field on an electronic device in response to the detecting.

2. The method of claim 1, further comprising detecting a touch meeting a second threshold, which touch is detected on the first physical key, and entering at least the first character of the at least one character as input.

3. The method of claim 1, wherein the displaying comprises previewing at least the first character while the touch meets the first threshold and discontinuing the previewing when the touch does not meet the first threshold.

4. The method of claim 3, wherein previewing comprises displaying at least the first character in a first format different than a second format of characters entered in the information entry field.

5. The method of claim 3, wherein previewing comprises at least one of:
displaying a faded version of at least the first character;
displaying at least the first character in a font that is different than the font of characters previously entered in the information entry field;
displaying at least the first character in a color that is different than the color of characters previously entered in the information entry field;
displaying a blinking, highlighted, or animated version of at least the first character;
displaying an underscored, italicized, or bolded version of at least the first character;
displaying a shaded, shadowed, enlarged, or shrunken version of at least the first character.

6. The method of claim 1, further comprising:
detecting a second touch meeting the first threshold, which second touch is detected on a second physical key;
displaying at least one character associated with the second physical key in the information entry field in response to detecting the second touch.

7. The method of claim 1, further comprising:
detecting a second touch meeting the first threshold, which touch is detected on a second physical key;
identifying a second character associate with the first physical key;
displaying at least the second character associated in the information entry field in response to detecting the second touch.

8. The method of claim 1, further comprising moving a text indicator through characters displayed in the information entry field based on relative movement of detected touches on a plurality of physical keys.

9. The method of claim 1, wherein the first threshold is a force threshold.

10. The method of claim 1, wherein the first threshold is a time threshold.

11. The method of claim 1, further comprising, when the touch is associated with a number during a phone application, displaying the number and at least one character associated with the number from a number-character mapping.

12. The method of claim 1, wherein the at least one character comprises a number and at least one character associated with the number from a number-character mapping.

13. The method of claim 1, further comprising:
when the touch is associated with a number in a phone application, displaying the number and one or more characters associated with the number;
detecting entry of the number;
identifying a first character of the one or more characters;
displaying at least one of the number and the first character when entry of the number is detected.

14. A computer-readable medium having computer-readable code executable by at least one processor of the portable electronic device to perform the method of claim 1.

15. An electronic device comprising:
a display;
a plurality of physical keys;
a processor operably coupled to the display and the plurality of keys and configured to:
detect a first touch meeting a first threshold, which first touch is detected on a first physical key of the plurality of physical keys;
display and not enter at least a first character associated with the first physical key on the display in an information entry field in response to the detecting.

16. The electronic device of claim 15, wherein the first physical key comprises a touch-sensitive element for detecting the first touch.

17. The electronic device of claim 15, wherein the first threshold is a time threshold.

18. The electronic device of claim 15, wherein the first physical key comprises a force sensor and the first threshold is a force threshold.

19. The electronic device of claim 15, wherein the processor is further configured to detect a touch meeting a second threshold, which touch is detected on the first physical key, and to enter at least the first character of the at least one character as input to the electronic device.

20. The electronic device of claim 15, wherein displaying comprises previewing at least the first character while the touch meets the first threshold and discontinuing the previewing when the touch does not meet the first threshold.
